(19) United States
(12) Patent Application Publication
(10) Pub. No.: US 2026/0005577 A1
(43) Pub. Date: Jan. 1, 2026

(54) ELECTRICAL MACHINE

(71) Applicant: BATHWICK ELECTRICAL DESIGN LTD, Bath, GBN (GB)

(72) Inventors: David RODGER, Bath (GB); Hong Cheng LAI, Bath (GB); John Lewis OUTRAM, Staffordshire (GB)

(73) Assignee: BATHWICK ELECTRICAL DESIGN LTD, Bath, GBN (GB)

(21) Appl. No.: 18/881,712

(22) PCT Filed: Jul. 6, 2023
(86) PCT No.: PCT/EP2023/068676

§ 371 Date: Jan. 6, 2025

(30) Foreign Application Priority Data
Jul. 7, 2022 (GB) 2209991.5

(51) Int. Cl. H02K 7/09; H02K 1/14; H02K 1/2706; H02K 7/18; H02K 15/02; H02K 15/40; H02K 15/50; H02K 16/02

(52) U.S. Cl. CPC H02K 7/09; H02K 1/14; H02K 1/2706; H02K 7/1838; H02K 15/02; H02K 15/40; H02K 15/50; H02K 16/02; H02K 2201/18; H02K 2213/06; H02K 2213/12

(57) ABSTRACT

An electrical machine is described which comprises: a rotor; a plurality of stator units each extending only partway about a circumference of the rotor; wherein each stator unit is movably mounted to the rotor by a plurality of bearings such that the stator unit can move relative to the rotor in a radial and/or axial direction and wherein each stator unit is fixed in position in a circumferential direction; wherein the electrical machine comprises a magnetic system arranged such that rotation of the rotor generates an electric current in each stator unit and/or an electric current in each stator unit causes rotation of the rotor. A system comprising an electrical machine and a remote assembly and maintenance apparatus is also described, along with methods of assembling and disassembling an electrical machine.

### CROSS REFERENCE TO RELATED APPLICATIONS

This application is a U.S. national stage of PCT/EP2023/068676 filed Jul. 6, 2023 which claims priority to United Kingdom Patent Application 2209991.5 filed on Jul. 7, 2022, the contents of which are incorporated herein.

### TECHNICAL FIELD

The present disclosure relates to an electrical machine and methods of assembling and disassembling an electrical machine.

### BACKGROUND

Wind turbines typically employ blades attached to a hub. When the wind blows, the blades cause the hub to rotate.

An electrical generator is driven by the hub and electricity is produced. Large wind turbine hubs run at a low speed, typically less than 10 rpm for a machine rated at 10 MW or more. The larger the wind turbine power, the slower the hub speed.

Often a mechanical gearbox is used between the wind turbine hub and the electrical generator to increase the speed of the generator. Speeding up the generator has the effect of reducing the cost and mass of the generator. The gearbox is however heavy and expensive in large sizes and can require maintenance.

It is also possible to use a generator without a mechanical gearbox, so that the generator runs at the same speed as the hub. This configuration is often referred to as a direct drive generator. Direct drive generators are physically larger and heavier than geared generators but may be regarded as being easier to maintain.

One of the drawbacks of direct drive generators is the relatively small airgap which must be maintained between the rotor and stator of the machine. Often this airgap has a thickness of the order of 1/1000 of its diameter. In practice, this can result in maintaining a mechanical clearance of around 10 mm between two surfaces at a diameter of the order of 10 m, which move relative to each other. In order to maintain such clearances, it is typically necessary for both the rotating structure (the rotor) and the stationary structure (the stator) to be extremely rigid between the airgap and the bearings that form the rotating interface between them. This rigidity requirement contributes extra mass and cost to the machine.

It is therefore desirable to address or alleviate the issues associated with conventional arrangements.

### SUMMARY

According to an aspect of the disclosure, there is provided an electrical machine comprising: a rotor; a plurality of stator units each extending only partway about a circumference of the rotor; wherein each stator unit is movably mounted to the rotor by a plurality of bearings such that the stator unit can move relative to the rotor in a radial and/or axial direction and wherein each stator unit is fixed in position in a circumferential direction; wherein the electrical machine comprises a magnetic system arranged such that rotation of the rotor generates an electric current in each stator unit and/or an electric current in each stator unit causes rotation of the rotor.

The rotor may be configured to rotate about a fixed axial position.

The rotor may comprise a pair of circular guide rails which project axially from each side of the rotor. The bearings of each stator unit may comprise a pair of radially outer bearings and a pair of radially inner bearings which interact with radially outer and radially inner circumferential surfaces of the circular guide rails in order to control a radial position of the stator unit.

The bearings of each stator unit may comprise a pair of axial bearings which interact with sidewall portions of the rotor in order to control an axial position of the stator unit.

The sidewall portions may be provided by axial end surfaces of the circular guide rails.

The rotor may comprise a pair of circular guide rails which project from each side of the rotor and each define radially outer and radially inner circumferential surfaces which are angled with respect to one another; wherein the bearings of each stator unit comprise a pair of radially outer bearings and a pair of radially inner bearings which interact with the radially outer and radially inner circumferential surfaces of the circular guide rails in order to control a radial and an axial position of the stator unit

The plurality of bearings may comprise non-contact bearings.

The non-contact bearings may be magnetic bearings and/or air bearings.

The plurality of bearings may comprise contact bearings, such as rolling-element bearings.

The contact bearings may support each stator unit on the rotor in the event of a failure of the non-contact bearings and/or during shutdown.

The rotor may be a first rotor and the stator unit may further comprise a second rotor. The first rotor may comprise a first arrangement of magnets and the second rotor may comprise a second arrangement of magnets. The first and second arrangements of magnets may be configured such that rotation of the first rotor causes rotation of the second rotor.

The second rotor may be configured to rotate about a rotational axis which is perpendicular to a rotational axis of the first rotor.

The first arrangement of magnets may comprise a helical arrangement and the second arrangement of magnets may comprise a corresponding helical arrangement.

The rotor may comprise a plurality of rotor sections which are separable from one another. The number of rotor sections may correspond to the number of stator units.

In accordance with another aspect, there is provided a system comprising an electrical machine as described above and a remote assembly and maintenance apparatus. The remote assembly and maintenance apparatus may comprise a lifting arm which is configured to remove each of the stator units from the electrical machine and/or insert each of the stator units into the electrical machine.

The remote assembly and maintenance apparatus may be configured to remove or

insert each stator unit with a corresponding rotor section attached thereto.

The remote assembly and maintenance apparatus may be configured to mechanically, electrically, hydraulically and/or pneumatically disconnect and/or connect each stator unit and/or corresponding rotor section.

The remote assembly and maintenance apparatus may be rotatable about the electrical machine in order to be angularly aligned with each stator unit.

The plurality of stator units may be rotatable about the electrical machine to allow each stator unit to be brought into angular alignment with the remote assembly and maintenance apparatus

In accordance with another aspect, there is provided a wind turbine comprising an electrical machine or system as described above.

In accordance with another aspect, there is provided a method of disassembling an electrical machine, the electrical machine comprising: a rotor having a plurality of rotor sections which are separable from one another; and a plurality of stator units each extending only partway about a circumference of the rotor; wherein the number of stator units corresponds to the number of rotor sections; the method comprising: rotating the rotor so that each rotor section is aligned with a corresponding stator unit; disconnecting one of the rotor sections from the adjacent rotor sections; and removing said rotor section with the corresponding stator unit attached to it.

In accordance with another aspect, there is provided a method of assembling an electrical machine, the electrical machine comprising: a rotor having a plurality of rotor sections which are separable from one another; and a plurality of stator units each extending only partway about a circumference of the rotor; wherein the number of stator units corresponds to the number of rotor sections; the method comprising: providing a plurality of assemblies, each assembly comprising a rotor section and a corresponding stator unit which is attached to the rotor section; bringing together the plurality of assemblies and connecting the rotor section of each assembly to rotor sections of adjacent assemblies to form the rotor; and disconnecting the rotor section from the stator unit of each assembly so as to allow the rotor to rotate relative to the stator units.

### BRIEF DESCRIPTION OF THE DRAWINGS

For a better understanding of the present disclosure, and to show how it can be put into effect, reference will now be made, by way of example, to the accompanying drawings, in which:

FIG. 1 is a schematic, cross-sectional view of an electrical machine according to an embodiment of the disclosure;

FIG. 2 is a rear view of the electrical machine;

FIG. 3 shows an example of a stator unit engaged with a generator rotor of the electrical machine;

FIG. 4 shows a cross-section through FIG. 3;

FIG. 5 shows a helical arrangement of magnets used in the electrical machine;

FIG. 6 shows a cross-section through an alternative example of a stator unit engaged with a generator rotor;

FIG. 7 shows an electrical machine with a remote assembly and maintenance apparatus;

FIG. 8 shows a cross-section through an alternative example of a stator unit engaged with a generator rotor; and

FIG. 9 shows an alternative arrangement of primary and secondary bearings.

### DETAILED DESCRIPTION

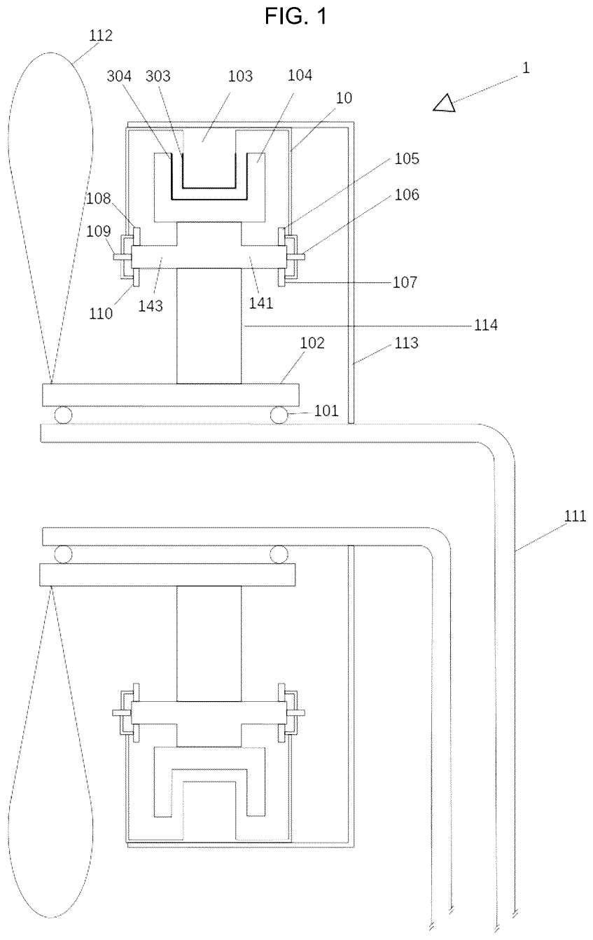

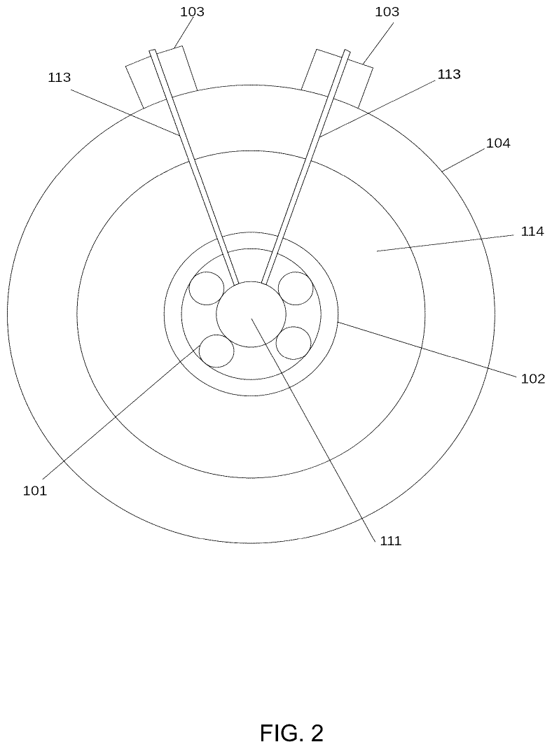

FIGS. 1 and 2 show an electrical machine 1 according to an embodiment of the disclosure which, in this example, is a wind turbine generator.

The electrical machine 1 comprises a hub 102 which is rotatably mounted to a tower 111 by bearings 101. A plurality of blades 112 extend radially from the hub 102. A generator rotor 114 extends radially from the hub 102 at a position which is spaced axially from the blades 112. The generator rotor 114 is therefore configured to rotate about a fixed axial position.

The generator rotor 114 is generally circular and comprises a pair of circular guide rails 141, 143 which project axially from each side of the generator rotor 114. The generator rotor 114 further comprises a trough section 104 provided at an outer circumferential portion of the generator rotor 114. The trough section 104 defines a pair of opposing axial surfaces which run parallel to one another and are spaced from one another by an inner radial surface. The trough section 104 runs around the circumference of the generator rotor 114 and thus forms a toroid. In other examples, the trough section 104 may be curved, e.g., having a semi-circular (or other circular segment) cross-section, and so forms an open torus. As a further example, troughs with different aspect ratios can be used to accommodate preferences for predominantly axial, radial or other magnetic flux patterns. For a purely radial flux machine, the opposing axial surfaces (i.e. the side walls) of the trough may be removed, and for a purely axial flux machine, the inner radial surface may be removed.

A plurality of stator units 103 are disposed about the circumference of the generator rotor 114 (only two stator units 103 are shown in FIG. 2 for clarity, but further units may be provided spaced around the circumference). Each stator unit 103 extends only partway about the circumference of the generator rotor 114. It will be appreciated that the stator units 103 may be located radially inward of an outermost circumference of the generator rotor 114 and so references to “circumference” should be constructed accordingly. Each stator unit 103 is disposed within the trough section 104 of the generator rotor 114. The generator rotor 114 interacts with the stator units 103 in order to generate electricity during rotation of the generator rotor 114 as a result of the force of wind against the blades 112. In particular, in this example, a winding 303 (electromagnetic coil) is provided on each stator unit 103 and magnets 304 are provided on the generator rotor 114. The magnets 304 are provided within the trough section 104 of the generator rotor 114 on its inner radial surface and the opposing axial surfaces. The movement of the magnets 304 relative to the winding 303 thus induces a current in the winding 303 to produce electrical energy.

It will be appreciated that other magnetic systems may be used. In particular, in other examples, only a subsection of the mutually adjacent surfaces may be magnetised. Further, the magnets 304 on the generator rotor 114 may be replaced with, for example, electrically conductive material or ferromagnetic poles in order to enable electricity generation to take place.

Each stator unit 103 is connected to an arm 113 which is in turn connected to the tower 111 (or some other part which remains stationary with respect to the generator rotor 114). The stator units 103 are thus held stationary in a circumferential direction with respect to the generator rotor 114 and are therefore unable to rotate with the generator rotor 114. The stator units 103 are, however, movably mounted in an axial and/or radial direction. In other examples, not all stator units 103 are connected to arms 113, instead being prevented from circumferential motion by coupling to adjacent stator units 103.

Specifically, as shown in FIG. 1, each stator unit 103 is coupled to the generator rotor 114 by a pair of axial bearings 106, 109 which engage (i.e., interact) with an axial end (sidewall) surface of the guide rails 141, 143 respectively, a pair of inner radial bearings 107, 110 which engage with a radially inner circumferential surface of the guide rails 141, 143 respectively and a pair of outer radial bearings 105, 108 which engage with a radially outer circumferential surface of the guide rails 141, 143 respectively. The bearings 105-110 are non-contact bearings, such as air or magnetic bearings. The bearings 105-110 are connected to the respective stator unit 103 by a support structure 10. In turn, the support structure 10 or the stator unit 103 itself is movably connected in an axial and/or radial direction to the arm 113. The bearings 105-110 track deviations in the radial and axial position of the guide rails 141, 143 such that the stator unit 103 remains in registration with the generator rotor 114 as it rotates. A consistent airgap is therefore maintained between the magnetic structures (provided the guide rails are locally accurately aligned with the rotor magnetic structure).

It will be appreciated that it may only be necessary to maintain a consistent airgap in an axial or radial direction, depending on where the magnetic structures are provided, and so the radial or axial bearings may be omitted. Further, forces from the magnetic structures may make it possible to maintain the airgap with some of the bearings being omitted.

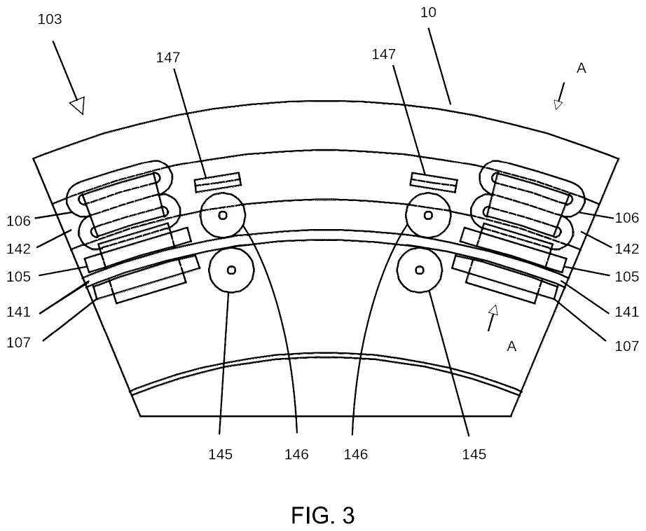

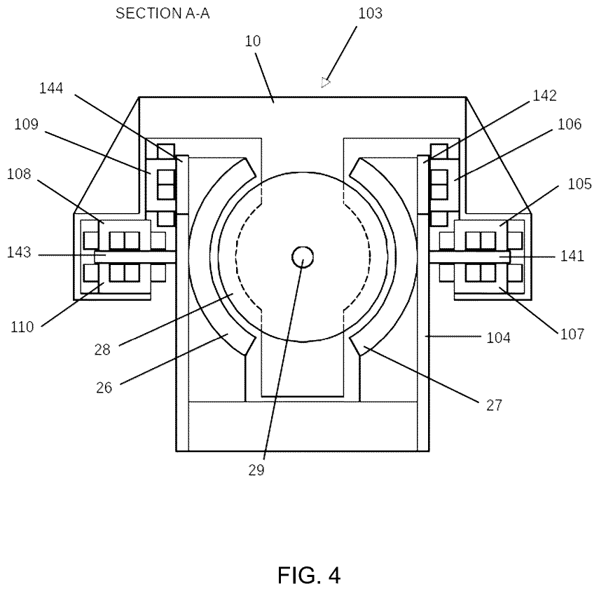

FIGS. 3 and 4 show an alternative example. As per the example described previously, the generator rotor 114 comprises a pair of circular guide rails 141, 143 which project axially from each side of the generator rotor 114. A first pair of inner radial bearings 107 is provided on one side of the generator rotor 114. The first pair of inner radial bearings 107 are spaced circumferentially from one another and engage with a radially inner circumferential surface of the guide rail 141. A second pair of inner radial bearings 110 is provided on the other side of the generator rotor 114. The second pair of inner radial bearings 110 are spaced circumferentially from one another and engage with a radially inner circumferential surface of the guide rail 143.

A first pair of outer radial bearings 105 is provided on one side of the generator rotor 114. The first pair of outer radial bearings 105 are spaced circumferentially from one another and engage with a radially outer circumferential surface of the guide rail 141. A second pair of outer radial bearings 108 is provided on the other side of the generator rotor 114. The second pair of outer radial bearings 108 are spaced circumferentially from one another and engage with a radially outer circumferential surface of the guide rail 143.

A first pair of axial bearings 106 is provided on one side of the generator rotor 114. The first pair of axial bearings 106 are spaced circumferentially from one another and engage with a first sidewall portion 142 of the generator rotor 114. A second pair of axial bearings 109 is provided on the other side of the generator rotor 114. The second pair of axial bearings 109 are spaced circumferentially from one another and engage with a second sidewall portion 144 of the generator rotor 114.

As described, in this example, the axial bearings 106, 109 engage with the sidewall portions 142, 144 instead of an axial end surface of the guide rails 141, 143, as described in the previous example. As shown in FIG. 4, the sidewall portions 142, 144 define part of the trough section 104.

In this example, the bearings 105-110 are magnetic bearings. In particular, each of the bearings 105-110 comprises an electromagnet which interacts with one of the guide rails 141, 143 and sidewall portions 142, 144 which are each formed from a ferromagnetic material. The electromagnets are connected to a power source, a gap sensor and a controller. Based on the output of the gap sensor, the controller is configured to regulate the current in the electromagnets in order maintain the desired airgap, using techniques which are well known to those skilled in the art. The guide rails may be laminated to reduce eddy-current losses.

Each magnetic bearing 105-110 is provided with a back-up contact bearing, for example a rolling element or a low friction block. Specifically, as shown in FIG. 3 (not shown in FIG. 4 for clarity), a pair of inner wheels 145 and a pair of outer wheels 146 are provided adjacent the radially inner and outer circumferential surfaces of the guide rail 141. A further pair of wheels 147 are provided adjacent the first sidewall portion 142. The rotational axis of the wheels 147 is perpendicular to the rotational axis of the inner and outer wheels 145, 146. A corresponding set of wheels 145-147 is provided on the other side of the generator rotor 114 which are adjacent the guide rail 143 and the second sidewall portion 144. The wheels 145-147 are spaced from the guide rails 141, 143 and the sidewall portions 142, 144 during normal operation but can engage with the guide rails 141, 143 and the first and second sidewall portions 142, 144 in the event of a failure of the magnetic bearings 105-110 (e.g., a power failure) where they are no longer able to maintain the airgap. The wheels 145-147 may also be brought into contact upon shutdown of the electrical machine 1. The wheels 145-147 thus prevent the stator units 103 from colliding with the generator rotor 114 and causing damage.

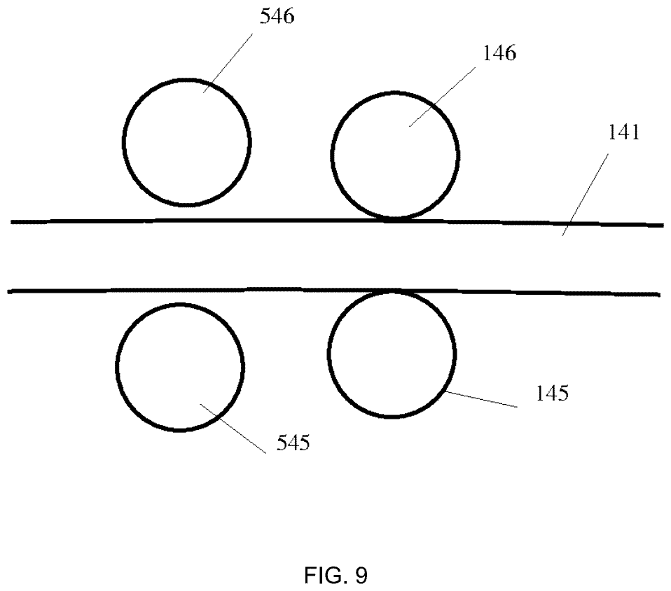

In other examples, the electrical machine 1 may not have any back-up bearings. Another arrangement, such as a backup battery or alternative power source, may be provided to protect the electrical machine 1 in the event of a failure of its primary power source. Alternatively, a further set of non-contact bearings may be provided to provide redundancy. The further set of non-contact bearings may be a different format to the primary bearings. For example, a set of air bearings may be included in addition to magnetic bearings, with the air bearings being activated (or taking over primary control) in the event of a failure of the magnetic bearings, or vice versa. In another example, the electrical machine 1 may have no non-contact bearings and instead only use contact bearings. For example, the electrical machine 1 may use multiple sets of contact bearings, with one set placed so as to provide redundancy in the event of failure of the primary set of contact bearings. An example is shown in FIG. 9, where the primary bearings, wheels 145 and 146, are arranged with a smaller clearance from the guide rail 141 than the secondary bearings, wheels 545 and 546.

The generator rotor 114 and the stator units 103 may form a magnetic gearing system, as described in WO2010026427 which is hereby incorporated by reference. Such an arrangement is shown in FIG. 4.

As shown, the stator unit 103 comprises a second rotor 28 which sits within the trough section 104 and is rotatable about an axis that is perpendicular to the rotational axis of the generator rotor 114. Specifically, the second rotor 28 is rotatably mounted to shaft 29 which, in turn, is connected to the support structure 10. The generator rotor 114 and the second rotor 28 of the stator unit 103 each comprise a plurality of magnets which are arranged such that rotation of the generator rotor 114 causes the second rotor 28 of the stator unit 103 to rotate about its axis.

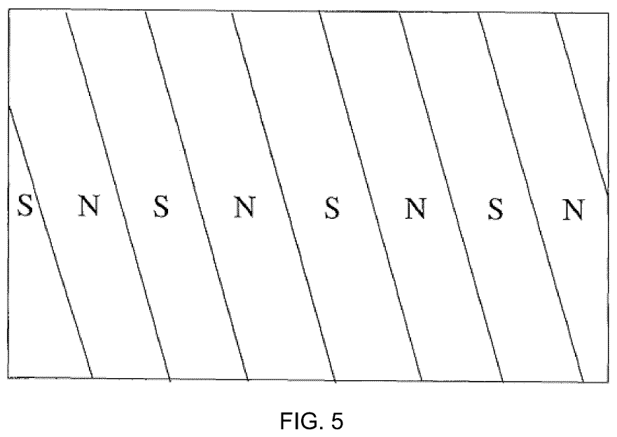

In particular, in this example, the second rotor 28 is substantially cylindrical (although it may curve along its length to conform to the trough section 104 of the generator rotor 114) and comprises a plurality of magnets (and/or ferromagnetic poles) which are arranged in a helical pattern about the circumference of the second rotor 28, as shown in FIG. 5. The trough section 104 of generator rotor 104 comprises a complementary arrangement of magnets (and/or ferromagnetic poles) which cooperate with the magnets of the second rotor 28. Specifically, the trough section 104 comprises a pair of toroidal magnetic thread sections 26, 27 (although, in other examples, a single toroidal magnetic thread section may be provided) which run parallel to the surface of the second rotor 28 to form a constant airgap.

The second rotor 28 of the stator unit 103 has a rotational radius that is much smaller than the rotational radius of the generator rotor 114 and, as a result, this arrangement produces a gearing effect with the second rotor 28 rotating more quickly than the generator rotor 114. Each stator unit 103 further comprises a stator element having a winding which interacts with the second rotor 28 to generate electricity. The second rotor 28 and its stator element may be referred to as a helix generator. In other examples, each individual stator unit 103 may be provided with a plurality of helix generators.

In an illustrative example, a 10 MW wind turbine may be formed with eight stator units 103, each housing four helix generators, so that 32 helix generators in total surround the generator rotor 114. With the arrangement of the present disclosure, each stator unit 103 is lightweight (compared to a single stator unit which extends around the entire circumference), perhaps of the order of 3t, and so can be easily transported by road.

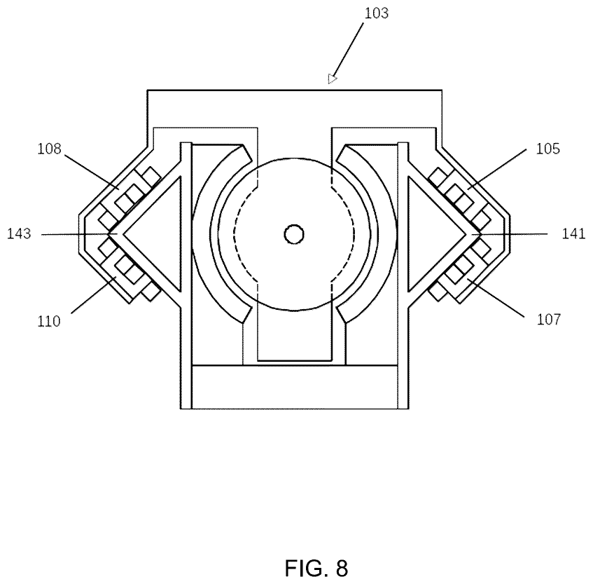

An alternative bearing arrangement is shown in FIG. 8. As shown, in this example, the guide rails 141, 143 each comprise a radially inner circumferential surface and a radially outer circumferential surface which are angled with respect to one another. The radially inner circumferential surface and the radially outer circumferential surfaces both extend in a direction having a radial and an axial component (e.g., at a 45 degree angle), but are angled in different directions (e.g., perpendicular to one another). A pair of inner bearings 107, 110 engage with the radially inner circumferential surface of the guide rails 141, 143 respectively and a pair of outer bearings 105, 108 engage with the radially outer circumferential surface of the guide rails 141, 143 respectively. With this arrangement, the inner bearings 107, 110 and the outer bearings 105, 108 are able to control the position in the radial and axial directions and so the axial bearings 106, 109 shown in FIG. 4 can be omitted.

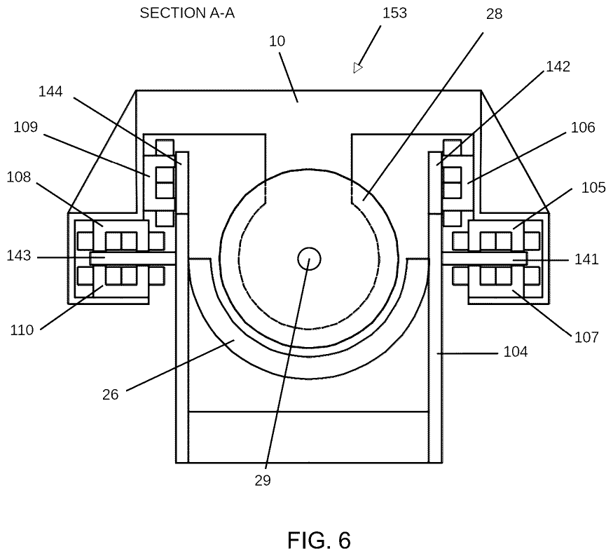

FIG. 6 shows an alternative arrangement in which a single toroidal magnetic thread section 26 is provided. As shown, the magnetic thread section 26 is formed by the revolution of a semi-circle (or other circular segment) and is open at its radially outer side (i.e., the concavity faces outwards). This arrangement allows the stator units 103 to be easily installed in and removed from the electrical machine 1 since the magnetic thread section 26 spans 180 degrees (or less), as is also the case in the example shown in FIG. 1.

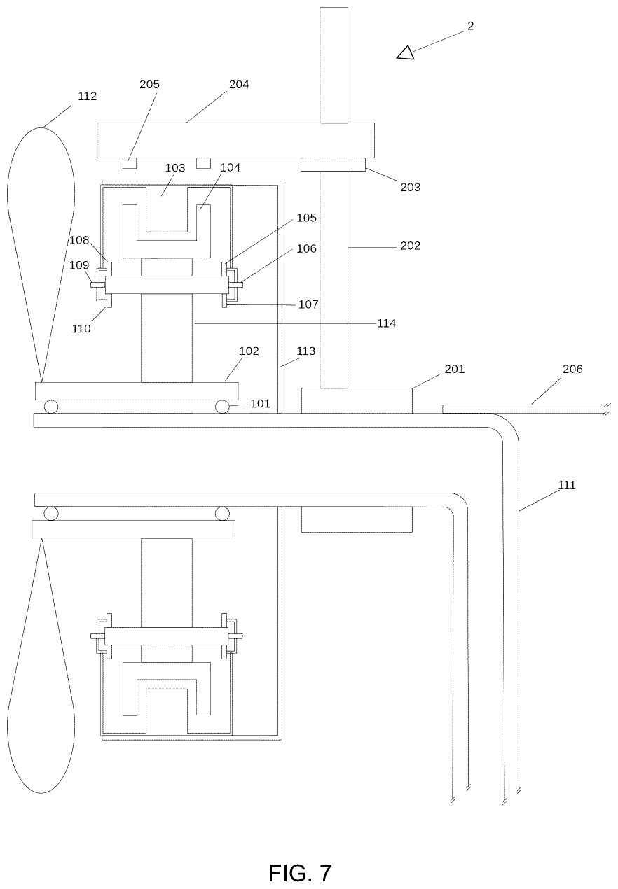

In particular, as shown in FIG. 7, the electrical machine 1 may be provided with a remote assembly and maintenance apparatus 2.

The remote assembly and maintenance apparatus 2 comprises a lifting arm 204 which is mounted to a column 202. The column 202 is affixed to the tower 111 via a bearing 201 and extends in a radial direction. The lifting arm 204 projects perpendicularly from the column 202 and is movable in the radial direction along the column 202. The lifting arm 204 is connected to the column 202 by a bearing 203 which allows the lifting arm 204 to rotate around the column 202 (i.e., within a plane which is perpendicular to the column 202). The lifting arm 204 comprises an end effector 205.

The column 202 is rotatable about the tower 111 via the bearing 201 to adopt different angular positions. In particular, the column 202 may be indexed into angular positions which correspond with the individual stator units 103. Alternatively, the stator units 103 and generator rotor 114 may index around to align with the remote assembly and maintenance apparatus 2.

In order to remove a stator unit 103, the column 202 is indexed into the corresponding angular position so that the lifting arm 204 is aligned with the stator unit 103. The lifting arm 204 may then translate along the column 202 in order to bring the end effector 205 into engagement with the stator unit 103. The end effector 205 is able to disconnect any mechanical, electrical, hydraulic and pneumatic connections between the stator unit 103 and the rest of the electrical machine 1, as required, and to clamp the stator unit 103 to the lifting arm 204.

The lifting arm 204 is then able to move radially outward along the column 202 in order to withdraw the stator unit 103 sufficiently. The lifting arm 204 can then rotate about the column 202 via the bearing 203 by substantially 180 degrees and can then deposit the stator unit 103 on nacelle floor 206. The required maintenance can be carried out before reversing the actions to reinsert the stator unit 103. Alternatively, a new stator unit can be installed.

This process may be repeated for other stator units 103 by rotating the column 202 about the tower 111. In other examples, the column 202 may be fixed and the stator units 103 may be rotated.

In other examples, the generator rotor 114 may be formed by a plurality of sections (rotor sections) which are assembled using fasteners. The rotor sections may be formed as circular sectors. Alternatively, the generator rotor 114 may be formed by a central disc and the rotor sections may be attached to the disc to form an annular ring extending around the disc (e.g., forming the trough section 104). The number of rotor sections corresponds to the number of stator units 103. A rotor section can therefore be removed with a corresponding stator unit 103, as described below.

The generator rotor 114 is first rotated so that the generator sections are aligned with the stator units (i.e., so that the edges of the stator units 103 line up with the edges of the rotor sections). The electrical machine 1 is then stopped and locked or braked so that no relative rotation between the generator rotor 114 and the stator units 103 is possible.

The end effector 205 can be used to clamp the stator unit 103 to the adjacent rotor section. The end effector can undo the fasteners holding the rotor section in place (e.g., to adjacent rotor sections and/or any common parts of the generator rotor 114) and also any electrical, hydraulic and pneumatic connections between the stator unit 103 and the rest of the electrical machine 1, as required. The lifting arm can then remove the rotor section, with the stator unit 103 still within the trough section 104.

Removing the stator unit 103 with the corresponding rotor section may be particularly beneficial where the stator unit 103 is held captive within the trough section 104, as in the example in FIG. 4. This may therefore avoid needing to dismantle the generator rotor 114 in order to release the stator unit 103. In other examples, the generator rotor 114 may be divided axially (forming two separate toroidal sections) in order to allow the stator unit 103 to be released.

It will be appreciated that in other examples, the stator unit 103 (and, where provided, the corresponding rotor section) may be withdrawn and inserted in an axial direction (i.e., substantially parallel to the rotational axis), along the length of the lifting arm 204, for example.

The entire electrical machine 1 can be remotely assembled on site, if required, using a similar set of actions to those described above. In particular, a plurality of assemblies each comprising a rotor section and a corresponding stator unit which is attached to the rotor section may be provided. The assemblies may then be brought together, and the rotor section of each assembly may be connected to rotor sections of adjacent assemblies to form the rotor. The rotor section may then be disconnected from the stator unit of each assembly so as to allow the rotor to rotate relative to the stator units.

When required, the end effector 205 can also be used to carry out more minor maintenance, such as replacing or fixing bearings 105-110, wheels 145-147 or other parts, without removing an entire stator unit 103 (and, where provided, the corresponding rotor section).

Some maintenance operations may be carried out without stopping the machine.

The modular nature of the electrical machine 1 allows it to be assembled and maintained remotely, if required. This may be particularly beneficial where the electrical machine 1 is located offshore, as is common with wind turbines. The assembly and maintenance process can be supervised remotely or locally by a human operator or by a computer using AI technology.

In the case of remotely controlled assembly and maintenance, communication links can be set up to enable the system responsible for carrying out these tasks on site (e.g., the assembly and maintenance apparatus 2 described above) to communicate and coordinate with remote command modules. Such communication links could include means to exchange data between the assembly/maintenance system and the command modules. Such communication links could also include means to exchange video or audio data or other auxiliary information between the assembly/maintenance system and the command modules.

Such communication links can be realised using undersea cables that support the type of communication desired. Such communication links can also be realised using satellite links, for example using VSAT stations, or mobile radio links, for example over a private network using LTE technology or suitable optical communications systems. The type of communication technology selected to realise such communication links is dependent on factors such as cost, reliability, distance from shore and so on.

Such communication links can be built exclusively with privately owned communication networks. Such communication links can also be built with a mixture of privately owned communication networks and publicly accessible communication networks. Such communication links can also use the Internet as part of the system.

The electrical machine 1 may also be provided with a remote monitoring system which monitors the health of the electrical machine and instructs the assembly and maintenance apparatus 2 where maintenance is required. For example, the remote monitoring system may regularly monitor bearings and other parts using a camera or other sensors and determine whether repair or replacement is needed.

Although the electrical machine 1 is described herein in the form of a generator, it will be appreciated that the electrical machine 1 may instead be used as a motor by supplying electricity to generate rotation.

The present disclosure allows a large wind turbine to be built from relatively small parts which can be easily handled without large capacity lifting equipment. Moreover, transportation by road becomes a possibility, since the limits on width and mass are easily met.

The arrangement of the present disclosure also makes partial assembly easier. In particular, one single stator unit 103 can be moved into one rotor section by wheeling it or sliding it along the circumferential direction. The stator unit 103 and rotor section can then be clamped together for safe transportation. This procedure allows a simple and safe solution to the well-known rotor threading problem where threading a magnetised rotor into a stator is difficult due to the very high magnetic forces potentially acting in a direction so as to cause the rotor and stator to collide.

Once on site, the electrical machine 1 can be arranged to assemble itself using the automated remote assembly and maintenance apparatus 2, as described above.

Remote maintenance is readily carried out using the remote assembly and maintenance apparatus 2. Since all but the large passive parts are relatively small, a stock of spare parts can be easily stored in the nacelle of each turbine to allow for rapid remote exchange, thereby minimising downtime.

Remote maintenance will also minimise downtime, minimise the use of ships in offshore wind farm maintenance, reduce the carbon footprint of onshore and offshore wind farm maintenance and reduce the danger to human life.

The remote assembly and maintenance apparatus 2 may be used with electrical machines having different features to those described previously. In particular, the remote assembly and maintenance apparatus 2 may be used with electrical machines having stator units which are supported on the rotor by rolling-element bearings only and not non-contact bearings.

The present disclosure minimises the need for rigidity in the rotor, and thus reduces weight and cost. In particular, by dividing the stator into a plurality of separate stator units, the rigidity requirement of the rotor is lowered to that which will allow the stator units to maintain clearance to the rotor locally, only over the relatively short length of each stator unit. The disclosure therefore allows the rotor to be globally more distorted than the local clearance between the rotor and stator units. For example if the nominal diameter of the rotor is 10 m then a tolerance on diameter of +20 mm would be acceptable, even if the local clearance is required to be 10 mm.

As described, the distance between each stator unit and the rotor may be maintained by a non-contact bearing system which actively maintains the required clearance only over the circumferential length of the relatively short stator unit. As described above, the non-contact bearing system may comprise air bearings or magnetic bearings, for example, which may be controlled to maintain a consistent airgap. Sensors may be used to monitor the airgaps and the output from the sensors may be used in a feedback loop to maintain the required gap.

Although the electrical machine 1 has been described with reference to a wind turbine, it will be appreciated that there are many other applications for which this disclosure would be useful, such as large, slow turning high torque motors for ship propulsion, tidal turbine generators, etc.

To avoid unnecessary duplication of effort and repetition of text in the specification, certain features are described in relation to only one or several aspects or embodiments of the disclosure. However, it is to be understood that, where it is technically possible, features described in relation to any aspect or embodiment of the disclosure may also be used with any other aspect or embodiment of the disclosure.

The disclosure is not limited to the embodiments described herein and may be modified or adapted without departing from the scope of the present disclosure.

1. An electrical machine comprising:
a rotor;
a plurality of stator units each extending only partway about a circumference of the rotor;
wherein each stator unit is movably mounted to the rotor by a plurality of primary bearings such that the stator unit can move relative to the rotor in a radial and/or axial direction and wherein each stator unit is fixed in position in a circumferential direction;
wherein the electrical machine comprises a magnetic system arranged such that rotation of the rotor generates an electric current in each stator unit and/or an electric current in each stator unit causes rotation of the rotor;
further comprising a plurality of secondary bearings, wherein, upon failure or unavailability of the primary bearings, the respective stator unit is movably mounted to the rotor by the plurality of secondary bearings.

2. The electrical machine as set forth in claim 1, wherein the rotor is configured to rotate about a fixed axial position.

3. The electrical machine as set forth in claim 1, wherein the rotor comprises a pair of circular guide rails which project axially from each side of the rotor; wherein the primary and/or secondary bearings of each stator unit comprise a pair of radially outer bearings and a pair of radially inner bearings which interact with radially outer and radially inner circumferential surfaces of the circular guide rails in order to control a radial position of the stator unit.

4. The electrical machine as set forth in claim 1, wherein the primary and/or secondary bearings of each stator unit comprise a pair of axial bearings which interact with sidewall portions of the rotor in order to control an axial position of the stator unit.

5. The electrical machine as set forth in claim 4, wherein the sidewall portions are provided by axial end surfaces of the circular guide rails.

6. The electrical machine as set forth in claim 1, wherein the rotor comprises a pair of circular guide rails which project from each side of the rotor and each define radially outer and radially inner circumferential surfaces which are angled with respect to one another; wherein the primary and/or secondary bearings of each stator unit comprise a pair of radially outer bearings and a pair of radially inner bearings which interact with the radially outer and radially inner circumferential surfaces of the circular guide rails in order to control a radial and an axial position of the stator unit.

7. The electrical machine as set forth in claim 1, wherein the plurality of primary and/or secondary bearings comprise non-contact bearings.

8. The electrical machine as set forth in claim 7, wherein the non-contact bearings are magnetic bearings and/or air bearings.

9. The electrical machine as set forth in claim 1, wherein the plurality of primary and/or secondary bearings comprise contact bearings

10. The electrical machine as set forth in claim 9, wherein the non-contact bearings are magnetic bearings and/or air bearings and the primary bearings comprise non-contact bearings and the secondary bearings comprise contact bearings.

11. The electrical machine as set forth in claim 1, wherein the rotor is a first rotor and the stator unit further comprises a second rotor; wherein the first rotor comprises a first arrangement of magnets and the second rotor comprises a second arrangement of magnets;
wherein the first and second arrangements of magnets are configured such that rotation of the first rotor causes rotation of the second rotor.

12. The electrical machine as set forth in claim 11, wherein the second rotor is configured to rotate about a rotational axis which is perpendicular to a rotational axis of the first rotor.

13. The electrical machine as set forth in claim 11, wherein the first arrangement of magnets comprises a helical arrangement and the second arrangement of magnets comprises a corresponding helical arrangement.

14. The electrical machine as set forth in claim 1, wherein the rotor comprises a plurality of rotor sections which are separable from one another; wherein the number of rotor sections corresponds to the number of stator units.

15. A system comprising the electrical machine as set forth in claim 1 and a remote assembly and maintenance apparatus; wherein the remote assembly and maintenance apparatus comprises a lifting arm which is configured to remove each of the stator units from the electrical machine and/or insert each of the stator units into the electrical machine.

16. The system as set forth in claim 15, further including a remote assembly and maintenance apparatus; wherein the remote assembly and maintenance apparatus comprises a lifting arm which is configured to remove each of the stator units from the electrical machine and/or insert each of the stator units into the electrical machine and wherein the remote assembly and maintenance apparatus is configured to remove or insert each stator unit with a corresponding rotor section attached thereto.

17. The system as set forth in claim 15, wherein the remote assembly and maintenance apparatus is configured to mechanically, electrically, hydraulically and/or pneumatically disconnect and/or connect each stator unit and/or corresponding rotor section.

18. The system as set forth in claim 15, wherein the remote assembly and maintenance apparatus is rotatable about the electrical machine in order to be angularly aligned with each stator unit.

19. The system as set forth in claim 15, wherein the plurality of stator units are rotatable about the electrical machine to allow each stator unit to be brought into angular alignment with the remote assembly and maintenance apparatus.

20. A wind turbine comprising an electrical machine as set forth in claim 1.

21. A method of disassembling an electrical machine, the electrical machine comprising:
a rotor having a plurality of rotor sections which are separable from one another; and
a plurality of stator units each extending only partway about a circumference of the rotor;
wherein the number of stator units corresponds to the number of rotor sections;
the method comprising:
rotating the rotor so that each rotor section is aligned with a corresponding stator unit;
disconnecting one of the rotor sections from the adjacent rotor sections; and
removing said rotor section with the corresponding stator unit attached to it.

22. A method of assembling an electrical machine, the electrical machine comprising:
a rotor having a plurality of rotor sections which are separable from one another; and
a plurality of stator units each extending only partway about a circumference of the rotor;
wherein the number of stator units corresponds to the number of rotor sections;
the method comprising:
providing a plurality of assemblies, each assembly comprising a rotor section and a corresponding stator unit which is attached to the rotor section;
bringing together the plurality of assemblies and connecting the rotor section of each assembly to rotor sections of adjacent assemblies to form the rotor; and
disconnecting the rotor section from the stator unit of each assembly so as to allow the rotor to rotate relative to the stator units.
